(19) United States
(12) Patent Application Publication
(10) Pub. No.: US 2024/0202063 A1
(43) Pub. Date: Jun. 20, 2024

(54) ROOT CAUSE ANALYSIS METHOD, APPARATUS AND SYSTEM IN CLOUD ENVIRONMENT

(71) Applicant: FOUNDATION OF SOONGSIL UNIVERSITY INDUSTRY COOPERATION, Seoul (KR)

(72) Inventor: Young Han KIM, Seoul (KR)

(21) Appl. No.: 18/544,720

(22) Filed: Dec. 19, 2023

(30) Foreign Application Priority Data
Dec. 19, 2022 (KR) 10-2022-0178012
Sep. 26, 2023 (KR) 10-2023-0129101

(51) Int. Cl. G06F 11/07

(52) U.S. Cl. CPC G06F 11/079; G06F 11/0793

(57) ABSTRACT

A root cause analysis system for analyzing a root cause in a cloud environment comprises: an infra controller searching a data source endpoint, and bringing address and port information of the data source endpoint when a monitoring agent is installed in a plurality of clusters; a monitoring module registering the address and port information of the data source endpoint according to a request of the intra controller, and collecting data from the monitoring agent in real time; a prediction and localization module predicting an abnormal accident in the plurality of clusters by inputting the data collected in real time into a machine learning-based prediction model, and searching a root cause of the abnormal accident by using a feature score and a log score for a metric of the abnormal accident; and a remediation (treatment) module performing a preliminary recovery process according to the searched root cause.

### CROSS-REFERENCE TO RELATED APPLICATION

This application claims under 35 U.S.C. § 119(a) the benefit of Korean Patent Application No. 10-2022-0178012 filed on Dec. 19, 2022, and Korean Patent Application No. 10-2023-0129101 filed on Sep. 26, 2023, the entire contents of which are incorporated herein by reference.

### BACKGROUND

### (a) Technical Field

The present disclosure relates to a method, an apparatus and a system for analyzing a root cause in a cloud environment.

### (b) Background Art

A cloud infrastructure is becoming more and more complicated to accommodate the growth of a cloud service.

Data monitoring, accident predictions and detection solutions are very important for operating and maintenance.

In a cloud environment, the development of container technology has raised new tasks on an issue of monitoring, predicting and detecting abnormal phenomena and a root causes analysis (RCA) issue.

In a mixed cloud environment configured by an application made into a container through a virtual machine, multiple alarms can be generated simultaneously in a cloud system due to a single fault.

An existing solution of data monitoring, accident prediction and root cause analysis is mainly based on human manual supervision. In the mixed cloud environment, there are the following restrictions in distributing the existing solution.

First, the cloud is a large-scale system and a multi-tenant environment. Due to the complex dependencies between apparatuses, components, and applications of the system, it is difficult to detect accidents and analyze a root cause. A root cause analysis system is required to understand an operation context, and distinguish a situation in which the fault can influence another component or class from a collocation fault.

Second, the cloud is a flexible system in which a workload can automatically request or release a resource as necessary. Consequently, a lot of monitoring signals should be monitored and collected, and the workload is frequently changed, so an operation environment becomes complicated. Through this, the root cause analysis system can be extended, and should be effective for multi-dimensional signal processing.

In addition, due to infrastructure complexity of a dynamic workload, the cloud environment faces high-frequency accidents at various levels. Accordingly, the root cause analysis system should process an even higher fault frequency than an existing distribution system. In the root cause analysis system, it is necessary to collect, store, and process a large amount of observable data such as indicators, logs, activities, etc., other than single observation.

### SUMMARY OF THE DISCLOSURE

In order to solve the above problems in the related art, the present disclosure is to suggest a method, an apparatus, and a system for analyzing a root cause in a cloud environment, which enables a multi-dimensional signal processing, and can process a large amount of data.

In order to achieve the object, according to an embodiment of the present disclosure, provided is a root cause analysis system including: an infra controller searching a data source endpoint, and bringing address and port information of the data source endpoint when a monitoring agent is installed in a plurality of clusters; a monitoring module registering the address and port information of the data source endpoint according to a request of the infra controller, and collecting data from the monitoring agent in real time; a prediction and localization module predicting an abnormal accident in the plurality of clusters by inputting the data collected in real time into a machine learning-based prediction model, and searching a root cause of the abnormal accident by using a feature score and a log score for a metric of the abnormal accident; and a treatment (remediation) module performing a preliminary recovery process according to the searched root cause.

The monitoring module may include a data source management registering the address and port information of the data source endpoint according to the control of the infra controller; and a data collector receiving metric information regarding the data source endpoint from the data source management, and transmitting federate-endpoint-api information to the data source management.

The data source management may request monitoring to the data collector, and the data collector may collect data from the monitoring agent in real time.

The prediction and localization module may include a data processor continuously querying data to the data collector; a predictor predicting the abnormal accident by inputting a metric stream according to the query into the prediction model provided from the data process; and a root cause analyzer calculating a root score through a combination of the feature score acquired from the predictor for the abnormal accident and the log score acquired from the data processor.

The root cause analyzer may acquire the feature score for the abnormal accident through a response from the predictor, and acquire the feature score, and then request the log score to the data processor, wherein the data processor may transmit the log query to the data collector when receiving the log score request, and calculate the log score by receiving a response thereto.

The root cause analyzer may search a potential root cause of the abnormal accident through the root score.

The treatment (remediation) module may include a trigger receiving the potential root cause from the root cause analyzer; a message repository receiving a message query from the trigger, and transmitting a response thereto; and an action repository receiving an action query from the trigger, and transmitting a response thereto, wherein the trigger may transmit a PUSH notification to a notifier in order to notify a system state together with information on an accident occurrence time, an accident location, and the potential root cause.

According to another embodiment of the present disclosure, provided is a root cause analysis apparatus in a cloud environment, including: a processor; and a memory connected to the processor, wherein the memory stores program instructions executed by the processor to search a data source endpoint, and register address and port information of the data source endpoint when a monitoring agent is installed in a plurality of clusters, collect data from the monitoring agent in real time, predict an abnormal accident in the plurality of clusters by inputting the data collected in real time into a machine learning-based prediction model, search a root cause of the abnormal accident by using a feature score and a log score for a metric of the abnormal accident, and perform a preliminary recovery process according to the searched root cause.

According to still another embodiment of the present disclosure, provided is a method for analyzing a root cause in a cloud environment in an apparatus including a processor and a memory, including: searching a data source endpoint, and registering address and port information of the data source endpoint when a monitoring agent is installed in a plurality of clusters; collecting data from the monitoring agent in real time; predicting an abnormal accident in the plurality of clusters by inputting the data collected in real time into a machine learning-based prediction model; searching a root cause of the abnormal accident by using a feature score and a log score for a metric of the abnormal accident; and performing a preliminary recovery process according to the searched root cause.

According to yet another embodiment of the present disclosure, provided is a computer program stored in a computer-readable recording medium performing the method.

According to the present disclosure, there is an advantage in that multi-dimensional signal processing is enabled, and a large amount of data can be processed.

### BRIEF DESCRIPTION OF DRAWINGS

FIG. 1 is a diagram illustrating an automated root cause analysis architecture according to an embodiment of the present disclosure.

FIG. 2 is a diagram illustrating a monitoring procedure between a monitoring module of an A-RCA system and a cluster of a cloud infrastructure according to the embodiment of the present disclosure.

FIG. 3 is a diagram illustrating accident prediction, location determination, and a treatment (remediation) procedure of the system according to the embodiment of the present disclosure.

### DETAILED DESCRIPTION

The present disclosure may make various modifications and have various embodiments, and therefore specific embodiments will be illustrated in the drawings and described in detail in the detailed description. However, this is not intended to limit the present disclosure to specific embodiments, and it should be understood that the present disclosure covers all the modifications, equivalents and replacements included within the idea and technical scope of the present disclosure.

The terms used in the present specification are used only to describe specific embodiments, and are not intended to limit the present disclosure. A singular form includes a plural form unless the context clearly indicates otherwise. In this specification, it is to be understood that the terms “comprise” or “have” as used in the present specification are intended to designate the presence of stated features, numbers, steps, operations, components, parts or combinations thereof, but not to preclude the possibility of the presence or addition of one or more other features, numbers, steps, operations, components, parts, or combinations thereof.

In addition, the components of the embodiment described with reference to each drawing are not limitedly applied only to the corresponding embodiment, and may be implemented to be included in another embodiment within the scope of maintaining the technical idea of the present disclosure, and further, even if a separate explanation is omitted, it is natural that a plurality of embodiments may also be re-implemented as one embodiment.

In addition, in describing with reference to the accompanying drawings, the same components are assigned the same or related reference numerals regardless of the reference numerals, and redundant descriptions thereof will be omitted. In describing the present disclosure, a detailed description of related known technologies will be omitted if it is determined that they unnecessarily make the gist of the present disclosure unclear.

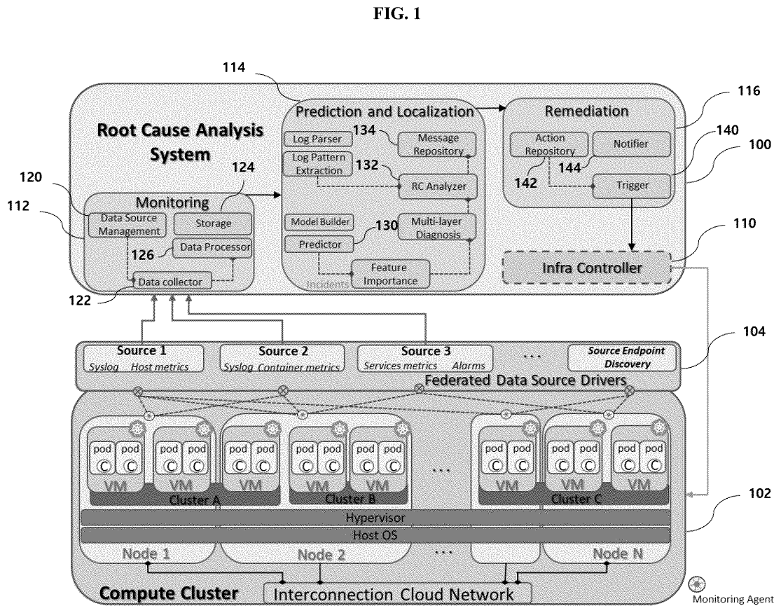

FIG. 1 is a diagram illustrating an automated root cause analysis architecture according to an embodiment of the present disclosure.

The automated root cause analysis system according to the embodiment may be defined as an automated root cause analysis (A-RCA) system 100.

The A-RCA system according to the embodiment is connected to a cloud computing infrastructure 102.

The cloud computing infrastructure 102 is constituted by a lot of logical clusters (Cluster A, Cluster B, . . . , Cluster C) including multiple virtual machines VM, and a monitoring agent is installed in a plurality of clusters to collect data in real time.

In the related art, container-based virtualization and virtual machine-based virtualization are independently considered in the cloud environment, but in the present disclosure, container-based and virtual machine-based new mixed cloud environments are constructed to solve multiple fault problems which occur in complexity of multiple layers of the cloud.

As illustrated in FIG. 1, federated data source drivers 104 for data federation of multiple monitoring agents between the A-RCA system 100 and the cloud infrastructure 102 are defined.

The federated data source drivers 104 according to the embodiment include metric data, log data, and event data to monitor and collect data in various data sources of the cloud infrastructure 102.

According to the embodiment, a data monitoring system collecting data from various data sources is considered for accident prediction and location determination.

The related art has used only a single data source (log or metric), and does not present an automatic mechanism that distributes a data endpoint to the system.

In the embodiment, an infra controller 110 of the A-RCA system 100 may aggregate various data sources.

According to the control of the infra controller 110, the monitoring module 112 of the A-RCA system 100 monitors and collects data in a numerical agent through various data sources included in the federated data source drivers 104.

The monitoring agent is injected into a multi-layer cloud infrastructure 102 to enable automated accident root cause analysis to include data and accidents (defects) of all layers of the system.

In the related art, the root cause analysis is applied only to a specific layer of the cloud infrastructure, primarily, an application layer, so the number of detected defects is limited, and a direct cause cannot be completely found.

However, in the embodiment, in order to find the root cause of the accident, all data sources (an infrastructure level, a platform level, and an application level) are searched.

A prediction and localization module 114 according to the embodiment provides automation of finding the root cause of the accident. Further, the root cause is more accurately identified with an accident which influences multiple layers of the cloud infrastructure 102.

A general method which depends only on implementation of a rule-based and policy-based system has a lot of difficulties in operation and management, and has low accuracy. Another difference between the related art and the embodiment is in the implementation of a system having closed loop features including data monitoring, prediction, localization, and treatment (remediation). A solution that detects the root cause, and then modifies the fault is automatically updated and distributed not to influence a service which is allowed to be stably executed.

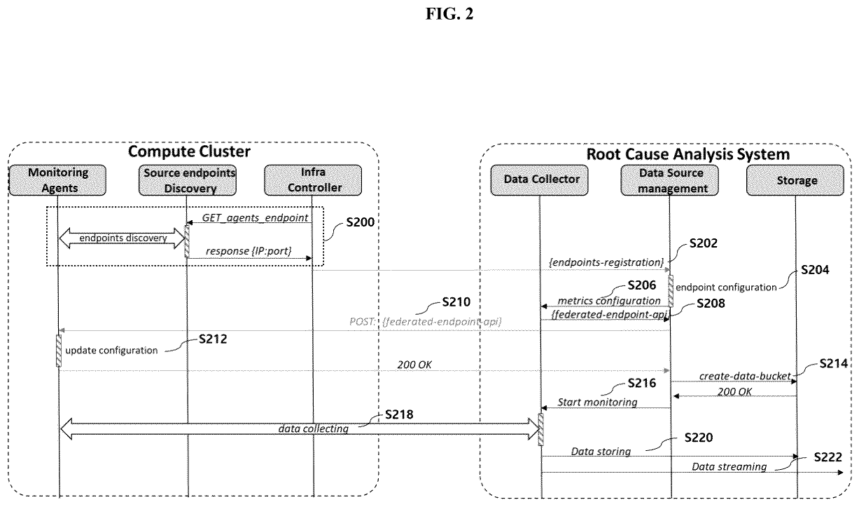

FIG. 2 is a diagram illustrating a monitoring procedure between a monitoring module of an A-RCA system and a cluster of a cloud infrastructure according to the embodiment.

Referring to FIG. 2, when the monitoring agent is installed in a plurality of clusters, the infra controller 110 searches a data source endpoint, and automatically updates information of the monitoring agent installed in the plurality of clusters (step 200).

In step 200, the infra controller brings address and port information of the endpoint.

The infra controller 110 registers the monitoring agent in a data source management 120 of a monitoring module 112 (step 202).

The data source management 120 registers different types of monitoring agents, and the corresponding address and port information (step 204), and transmits information on a metric to a data collector 122 (step 206).

Step 204 is defined as an endpoint configuration, and step 206 is defined as a metric configuration.

The data collector 122 responds ‘federate-endpoint-api’ information to the data source management 120 (step 208).

The data source management 120 transmits the ‘federate-endpoint-api’ information to each monitoring agent through a POST request (step 210).

Then, the monitoring agent performs an update process (step 212).

Further, a bucket is generated in a storage 124 in order to store collected data (step 214).

Last, the data source management 120 requests monitoring to the data collector 122 (step 216), and the data collector 122 collects from the monitoring agent in real time (step 218), and stores the collected data in the storage 124 (step 220).

Further, in the prediction and localization module, data streaming is provided to execute the accident prediction (step 222).

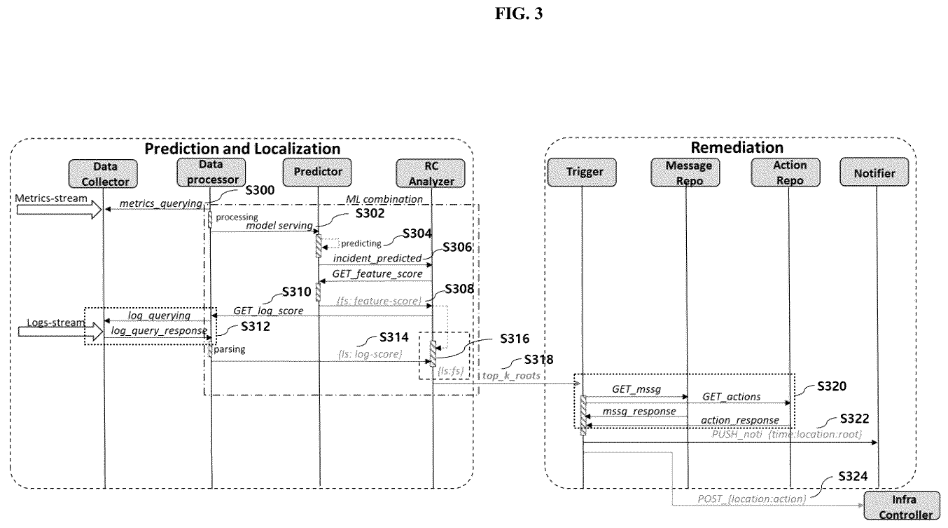

FIG. 3 is a diagram illustrating accident prediction, location determination, and a treatment (remediation) procedure of the system according to the embodiment.

The data processor 126 of the monitoring module 112 continuously queries the metric to the data collector 122 (step 300).

A machine learning-based prediction model is provided from the data processor 126 to a predictor 130 (step 302), and the prediction model serves to predict and detect an abnormal accident of the system to rapidly and accurately find a root cause (step 304).

When the predicted abnormal accident occurs in the system, the predictor 130 reports such a data sequence to a root cause analyzer 132 (step 306).

The root cause analyzer 132 acquires a feature score for the abnormal accident from the predictor 130 (step 308), and requests a log score to the data processor 126 (step 310).

The data processor 126 performs ‘log query’ for the data collector 122 and a log stream (step 312).

When a response to the log query is received from the data collector 122, the data processor 126 executes a syntax analysis log to calculate the log score at each level for the metric of the abnormal accident, and transmits the log score to the root cause analyzer (step 314).

The root cause analyzer 132 automatically determines a root score through a combination of the feature score and the log score, and searches a potential root cause of the predicted abnormal accident through the root score (step 316).

The root cause analyzer 132 searches a potential root cause corresponding to a highest root score, and transmits an available root cause top_k to a trigger 140 of a treatment (remediation) module 116 (step 318).

The trigger 140 transmits a GET request, and queries a message and an action in a message repository 134 and an action repository 142, and receives a response thereto (step 320).

Through step 320, a result root corresponding message and an action to be determined are associated with each other.

Next, the trigger 140 transmits a PUSH notification to a notifier 144 in order to notify a system state together with information on an accident occurrence time, an accident location, and the potential root cause (step 322).

Last, based on querying the corresponding action for recovery in the action repository 142, the trigger transmits the information to the infra controller, and determines and performs a preliminary recovery process, and minimizes a system error time (step 324).

The root cause analysis method according to the embodiment may be implemented even in the form of a recording medium including an instruction executable by a computer such as an application or a program module executed by the computer. A computer readable medium may be any available medium accessible by the computer or includes all of volatile and non-volatile media and removable and irremovable media. Further, the computer readable medium may include computer storage media. The computer storage media include all of the volatile and non-volatile and removable and irremovable media implemented by any method or technology for storing information such as a computer readable instruction, a data structure, a program module, or other data.

The root cause analysis method may be executed by an application (this may include a program included in a platform or an operating system basically installed in the terminal) basically installed in the terminal. In such a meaning, the root cause analysis method may be implemented by the application (i.e., program) basically installed in the terminal or directly installed by a user, and recorded in the computer readable recording medium such as the terminal.

The embodiment of the present disclosure is disclosed for the purpose of the example, and it will be apparent to those skilled in the art that various alterations, modifications, and additions are possible within the spirit and scope of the present disclosure, and such alterations, modifications, and additions should be considered as falling within the scope of the following claims.

What is claimed is:

1. A root cause analysis system in a cloud environment, comprising:
an infra controller searching a data source endpoint, and bringing address and port information of the data source endpoint when a monitoring agent is installed in a plurality of clusters;
a monitoring module registering the address and port information of the data source endpoint according to a request of the intra controller, and collecting data from the monitoring agent in real time;
a prediction and localization module predicting an abnormal accident in the plurality of clusters by inputting the data collected in real time into a machine learning-based prediction model, and searching a root cause of the abnormal accident by using a feature score and a log score for a metric of the abnormal accident; and
a remediation module performing a preliminary recovery process according to the searched root cause.

2. The root cause analysis system of claim 1, wherein the monitoring module comprises:
a data source management registering the address and port information of the data source endpoint according to the control of the infra controller; and
a data collector receiving metric information regarding the data source endpoint from the data source management, and transmitting federate-endpoint-api information to the data source management.

3. The root cause analysis system of claim 2, wherein the data source management requests monitoring to the data collector, and
the data collector collects data from the monitoring agent in real time.

4. The root cause analysis system of claim 1, wherein the prediction and localization module comprise:
a data processor continuously querying data to the data collector;
a predictor predicting the abnormal accident by inputting a metric stream according to the query into the prediction model provided from the data process; and
a root cause analyzer calculating a root score through a combination of the feature score acquired from the predictor for the abnormal accident and the log score acquired from the data processor.

5. The root cause analysis system of claim 4, wherein the root cause analyzer acquires the feature score for the abnormal accident through a response from the predictor, and acquires the feature score, and then requests the log score to the data processor, and
the data processor transmits the log query to the data collector when receiving the log score request, and calculates the log score by receiving a response thereto.

6. The root cause analysis system of claim 4, wherein the root cause analyzer searches a potential root cause of the abnormal accident through the root score.

7. The root cause analysis system of claim 6, wherein the remediation module comprises:
a trigger receiving the potential root cause from the root cause analyzer;
a message repository receiving a message query from the trigger, and transmitting a response thereto; and
an action repository receiving an action query from the trigger, and transmitting a response thereto,
wherein the trigger transmits a PUSH notification to a notifier in order to notify a system state together with information on an accident occurrence time, an accident location, and the potential root cause.

8. A root cause analysis apparatus in a cloud environment, comprising:
a processor; and
a memory connected to the processor,
wherein the memory stores program instructions executed by the processor to
search a data source endpoint, and register address and port information of the data source endpoint when a monitoring agent is installed in a plurality of clusters,
collect data from the monitoring agent in real time,
predict an abnormal accident in the plurality of clusters by inputting the data collected in real time into a machine learning-based prediction model,
search a root cause of the abnormal accident by using a feature score and a log score for a metric of the abnormal accident, and
perform a preliminary recovery process according to the searched root cause.

9. A method for analyzing a root cause in a cloud environment in an apparatus including a processor and a memory, the method comprising:
searching a data source endpoint, and registering address and port information of the data source endpoint when a monitoring agent is installed in a plurality of clusters;
collecting data from the monitoring agent in real time;
predicting an abnormal accident in the plurality of clusters by inputting the data collected in real time into a machine learning-based prediction model;
searching a root cause of the abnormal accident by using a feature score and a log score for a metric of the abnormal accident; and
performing a preliminary recovery process according to the searched root cause.

10. A computer program stored in a computer-readable recording medium performing the method of claim 9.
